(19) United States
(12) Patent Application Publication
(10) Pub. No.: US 2025/0078250 A1
(43) Pub. Date: Mar. 6, 2025

(54) DEFECT CLASSIFICATION SUPPORT APPARATUS, METHOD, AND NON-TRANSITORY COMPUTER READABLE MEDIUM

(71) Applicant: KABUSHIKI KAISHA TOSHIBA, Tokyo (JP)

(72) Inventors: Kentaro TAKAGI, Yokohama Kanagawa (JP); Toshiyuki OSHIMA, Tokyo (JP); Kouta NAKATA, Chigasaki Kanagawa (JP)

(73) Assignee: KABUSHIKI KAISHA TOSHIBA, Tokyo (JP)

(21) Appl. No.: 18/760,203

(22) Filed: Jul. 1, 2024

(30) Foreign Application Priority Data
Aug. 30, 2023 (JP) 2023-140427

(51) Int. Cl. G06T 7/00

(52) U.S. Cl. CPC G06T 7/001

(57) ABSTRACT

According to one embodiment, a defect classification support apparatus includes a processor. The processor acquires a defect image of an outer appearance of a target object having a defect. The processor extracts a defect patch image from the defect image, the defect patch image being a partial image that includes the defect. The processor extracts a normal patch image from the defect image, the normal patch image being a partial image free of the defect. The processor computes a feature amount of the defect based on the defect patch image and the normal patch image.

### CROSS-REFERENCE TO RELATED APPLICATIONS

This application is based upon and claims the benefit of priority from Japanese Patent Application No. 2023-140427, filed Aug. 30, 2023, the entire contents of which are incorporated herein by reference.

### FIELD

Embodiments described herein relate generally to a defect classification support apparatus, method, and non-transitory computer readable medium.

### BACKGROUND

In the process of manufacturing a product such as a semiconductor device to which a circuit pattern is transcribed, it is important to conduct defect inspection in order to improve the yield of the product. In a normal defect inspection, a partial image that includes a defect of a product (i.e., a defect patch image) is extracted from a captured image of an outer appearance of the product having the defect (i.e., a defect image). Then, the type of the defect in the defect patch image is classified by a machine learning model trained using a feature amount of the defect. Thus, in order to improve the accuracy of the defect classification performed by a machine learning model, it is necessary to highly accurately compute the feature amount of the defect.

A conventional method uses an image (a pseudo-normal patch image) obtained by pseudo-excluding a defect from a defect patch image in order to compute a feature amount of the defect in the defect patch image. Specifically, this method generates a pseudo-normal patch image from an image (a design image) of a product designed by software such as a CAD (computer aided design) and computes a feature amount of a defect in a defect patch image based on a difference between the pseudo-normal patch image and the defect patch image.

However, the above method may not be able to generate a pseudo-normal patch image from a design image with high precision. In this case, the above method cannot highly accurately compute a feature amount of a defect in a defect patch image.

### BRIEF DESCRIPTION OF THE DRAWINGS

FIG. 1 is a block diagram showing an example of a function configuration of a defect classification support apparatus according to an embodiment.

FIG. 2 is a flowchart showing an example of an operation of the defect classification support apparatus according to an embodiment.

FIG. 3 is a diagram showing an example of a defect image and an example of a normal image according to an embodiment.

FIG. 4 is a diagram showing a first example of extracting a normal patch image from a defect image according to an embodiment.

FIG. 5 is a diagram showing a second example of extracting a normal patch image from a defect image according to an embodiment.

FIG. 6 is a diagram showing a first example of extracting a normal patch image from a normal image according to an embodiment.

FIG. 7 is a diagram showing a second example of extracting a normal patch image from a normal image according to an embodiment.

FIG. 8 is a block diagram showing an example of a hardware configuration of the defect classification support apparatus according to an embodiment.

### DETAILED DESCRIPTION

In general, according to one embodiment, a defect classification support apparatus includes a processor. The processor acquires a defect image of an outer appearance of a target object having a defect. The processor extracts a defect patch image from the defect image, the defect patch image being a partial image that includes the defect. The processor extracts a normal patch image from the defect image, the normal patch image being a partial image free of the defect. The processor computes a feature amount of the defect based on the defect patch image and the normal patch image.

Hereinafter, an embodiment will be described with reference to the accompanying drawings. In the embodiment described below, elements assigned with the same reference symbols perform the same operations, and repeat descriptions will be omitted as appropriate.

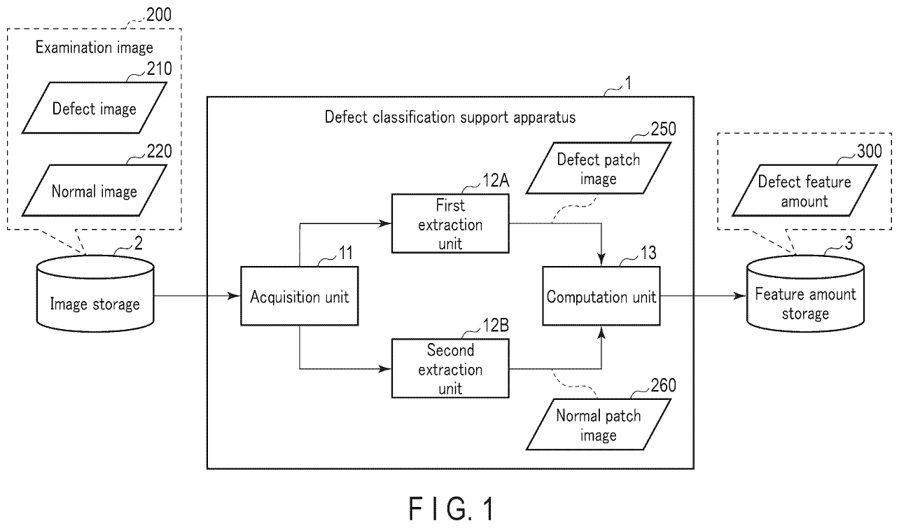

FIG. 1 is a block diagram showing an example of a function configuration of a defect classification support apparatus 1 according to an embodiment. The defect classification support apparatus 1 is an apparatus that supports classification of defects. The defect classification support apparatus 1 is communicably connected to an image storage 2 and a feature amount storage 3. The defect classification support apparatus 1 includes an acquisition unit 11, a first extraction unit 12A, a second extraction unit 12B, and a computation unit 13.

The acquisition unit 11 acquires various types of data. For example, the acquisition unit 11 acquires an examination image 200 from the image storage 2. Firstly, the acquisition unit 11 acquires a defect image 210 (i.e., an example of the examination image 200) of an outer appearance of a target object (e.g., a product, food, medicine, component) having a defect D. Secondly, the acquisition unit 11 acquires a normal image 220 (i.e., an example of the examination image 200) of an outer appearance of another target object free of a defect D. The acquisition unit 11 transfers the acquired defect image 210 to the first extraction unit 12A and the second extraction unit 12B. On the other hand, the acquisition unit 11 transfers the acquired normal image 220 to the second extraction unit 12B.

Preferably, a “target object” shown in the defect image 210 and “another target object” shown in the normal image 220 are different objects belonging to the same type. For example, a target object is a semiconductor device S1 to which a predetermined circuit pattern is transcribed, and another target object is a different semiconductor device S2 to which the same circuit pattern is transcribed.

The semiconductor device S1 has a defect D such as a foreign substance, contamination, damage, etc., and the semiconductor device S2 does not have a defect D.

The first extraction unit 12A extracts various types of data. For example, the first extraction unit 12A extracts a defect patch image 250 (a partial image) showing the defect D from the defect image 210. The first extraction unit 12A transfers the extracted defect patch image 250 to the computation unit 13. The first extraction unit 12A is also referred to as “a defect patch image extractor”.

The second extraction unit 12B extracts various types of data. For example, the second extraction unit 12B extracts a normal patch image 260 (a partial image) free of the defect D from the defect image 210 and the normal image 220. The second extraction unit 12B transfers the extracted normal patch image 260 to the computation unit 13. The second extraction unit 12B is also referred to as “a normal patch image extractor”.

The computation unit 13 computes various types of data. For example, the computation unit 13 computes a feature amount of the defect D (a defect feature amount 300) based on the defect patch image 250 and the normal patch image 260. In particular, the computation unit 13 may compute a feature amount relating to a normal feature excluding the defect D (a normal feature amount) based on a difference between the defect patch image 250 and the normal patch image 260. The computation unit 13 may compute the defect feature amount 300 relating to a defect feature of the defect D so as to suppress the normal feature amount. The computation unit 13 transfers the computed defect feature amount 300 to the feature amount storage 3.

The image storage 2 stores various images. For example, the image storage 2 stores at least one defect image 210 and at least one normal image 220. The image storage 2 transfers the defect image 210 and the normal image 220 to the acquisition unit 11 of the defect classification support apparatus 1.

The feature amount storage 3 stores various feature amounts. For example, the feature amount storage 3 stores the defect feature amount 300 transferred from the computation unit 13 of the defect classification support apparatus 1. The defect feature amount 300 may be a width, a length, or an area of an image region (a defect region) relating to the defect D. Alternatively, the defect feature amount 300 may be a total value, a maximum value, or an average value relating to pixel values of multiple pixels composing the defect region.

The image storage 2 and the feature amount storage 3 may be a processor-readable storage medium (e.g., a magnetic storage medium, an electromagnetic storage medium, an optical storage medium, a semiconductor memory) or a drive unit that writes or reads various types of data to and from a storage medium. The image storage 2 and the feature amount storage 3 may be integrated into a single storage.

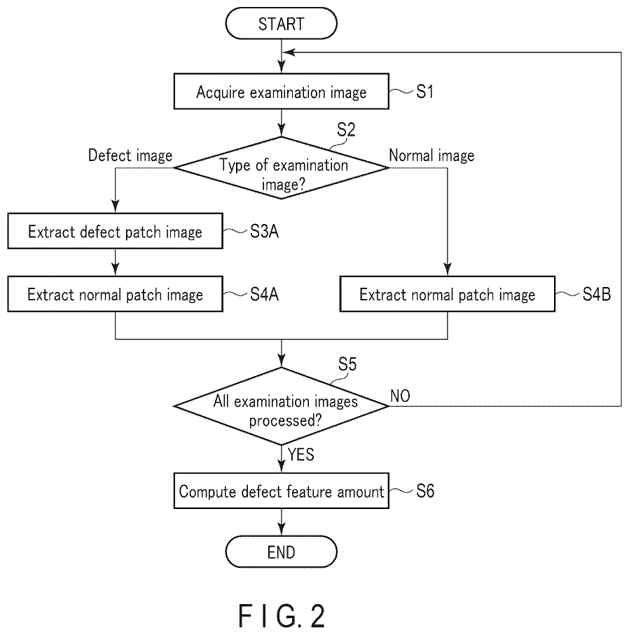

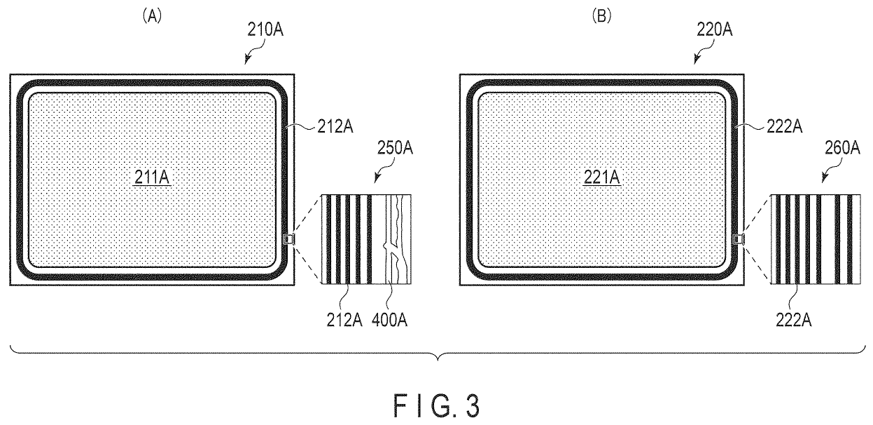

FIG. 2 is a flowchart showing an example of an operation of the defect classification support apparatus 1 according to an embodiment. In this example, the defect classification support apparatus 1 computes the defect feature amount 300 of the defect D in the defect image 210 based on at least one defect image 210. That is, the defect classification support apparatus 1 may compute the defect feature amount 300 without using the normal image 220.
(Step S1) First, the acquisition unit 11 acquires the examination image 200. For example, the acquisition unit 11 acquires any one of at least one examination image 200 stored in the image storage 2 (see FIG. 3).
(Step S2) Herein, the acquisition unit 11 determines the type (the defect image 210 or the normal image 220) of the examination image 200 acquired in step S1. For example, the acquisition unit 11 acquires, from an examination device that captures the examination image 200, a result of the estimation of a position of a defect in the examination image 200. Alternatively, by using an abnormality detection method (e.g., Patchcore) based on machine learning, the acquisition unit 11 acquires a result of the estimation of a position of a defect in the examination image 200. By using the acquired result of the estimation of a position of a defect, the acquisition unit 11 determines the type of the examination image 200.

For example, if the examination image 200 includes a position of a defect, the acquisition unit 11 determines that the examination image 200 is the defect image 210 (the type of examination image =defect image).

In this case, the acquisition unit 11 transfers the defect image 210 to the first extraction unit 12A and the second extraction unit 12B. The process then proceeds to step S3A. On the other hand, if the examination image 200 does not include a position of a defect, the acquisition unit 11 determines that the examination image 200 is the normal image 220 (the type of examination image =normal image). In this case, the acquisition unit 11 transfers the normal image 220 to the second extraction unit 12B. The process then proceeds to step S4B.
(Step S3A) In this case, the first extraction unit 12A extracts at least one defect patch image 250 from the defect image 210 transferred in step S2. For example, by using the result of the estimation of a position of a defect acquired in step S2, the first extraction unit 12A cuts out the defect patch image 250 focusing on the position of a defect from the defect image 210. If the position of a defect is given as a region, the first extraction unit 12A cuts out the defect patch image 250 so as to include this region. For example, the first extraction unit 12A cuts out the defect patch image 250 focusing on the center of gravity of this region (see FIG. 3).
(Step S4A) Subsequently, the second extraction unit 12B extracts at least one normal patch image 260 from the defect image 210 transferred in step S2. For example, by using the result of the estimation of a position of a defect acquired in step S2, the second extraction unit 12B specifies an image region in the defect image 210 excluding the position of a defect as an image region free of defects (i.e., a normal region NR). The second extraction unit 12B computes a distribution of the degree M of importance in the specified normal region NR. The second extraction unit 12B cuts out the normal patch image 260 from the defect image 210 according to the computed distribution of the degree M of importance. After step S4A, the process proceeds to step S5 (see FIGS. 3, 4, and 5).
(Step S4B) In this case, the second extraction unit 12B extracts at least one normal patch image 260 from the normal image 220 transferred in step S2. As mentioned above, unlike the defect image 210, the normal image 220 does not include any defects. Thus, the second extraction unit 12B specifies an entire image region in the normal image 220 as an image region free of defects (i.e., a normal region NR). The second extraction unit 12B computes a distribution of the degree M of importance in the specified normal region NR. The second extraction unit 12B cuts out the normal patch image 260 from the normal image 220 according to the computed distribution of the degree M of importance. After step S4B, the process proceeds to step s5 (see FIGS. 3, 6, and 7).

The second extraction unit 12B may adjust the number of normal patch images 260 extracted in steps S4A and S4B according to the number of defect patch images 250 extracted in step S3A. In general, the defect image 210 includes many normal regions relative to a small number of defect regions. Thus, the second extraction unit 12B may extract a large number of normal patch images 260, as compared to the defect patch image 250, from the defect image 210. Accordingly, the second extraction unit 12B may limit the number of normal patch images 260 according to the number of defect patch images 250. The second extraction unit 12B may use a method such as Coreset in order to limit the number of normal patch images 260.
(Step S5) Herein, the computation unit 13 determines whether or not all the examination images 200 have been processed through the series of processing steps from step S1 through step S4A or S4B. For example, the computation unit 13 determines whether or not the above-described series of processing steps has been performed on all the examination images 200 stored in the image storage 2. If all the examination images 200 have been processed (Step S5—YES), the process proceeds to step s6. On the other hand, if not all the examination images 200 have been processed (Step S5—NO), the process returns to step S1. (Step S6) Lastly, the computation unit 13 computes the defect feature amount 300 based on at least one defect patch image 250 extracted in step S3A and at least one normal patch image 260 extracted in steps S4A and S4B. For example, the computation unit 13 computes the defect feature amount 300 using a CIDFD (contrastive instance discrimination and feature decorrelation) method (see Japan Patent Application No. 2022-147323).

FIG. 3 is a diagram showing an example of the defect image 210 and an example of the normal image 220 according to an embodiment. FIG. 3(A) shows a defect image 210A and a defect patch image 250A. FIG. 3(B) shows a normal image 220A and a normal patch image 260A.

As shown in FIG. 3(A), the defect image 210A is an examination image 200 of a semiconductor device with a high resolution. In the defect image 210A, a circuit pattern 212A is transcribed in the periphery of a silicon substrate 211A. A part of the circuit pattern 212A has a defect 400A showing damage.

By using the result of the estimation of a position of a defect in the defect image 210A, the first extraction unit 12A cuts out the defect patch image 250A focusing on the position of a defect from the defect image 210A (refer to step S3A). The defect patch image 250A is an image that includes a part of the circuit pattern 212A and the defect 400A. The second extraction unit 12B may cut out the normal patch image 260 from an image region different from the image region in the defect image 210A that corresponds to the defect patch image 250A (refer to step S4A).

As shown in FIG. 3(B), the normal image 220A is an examination image 200 of another semiconductor device with a high resolution. In the normal image 220A, a circuit pattern 222A is transcribed in the periphery of a silicon substrate 221A. The normal image 220 A does not include a defect.

The second extraction unit 12B cuts out a partial image region from the normal image 220A as the normal patch image 260A (refer to step S4B). The normal patch image 260A is an image that includes a part of the circuit pattern 222A. The normal patch image 260A does not include a defect.

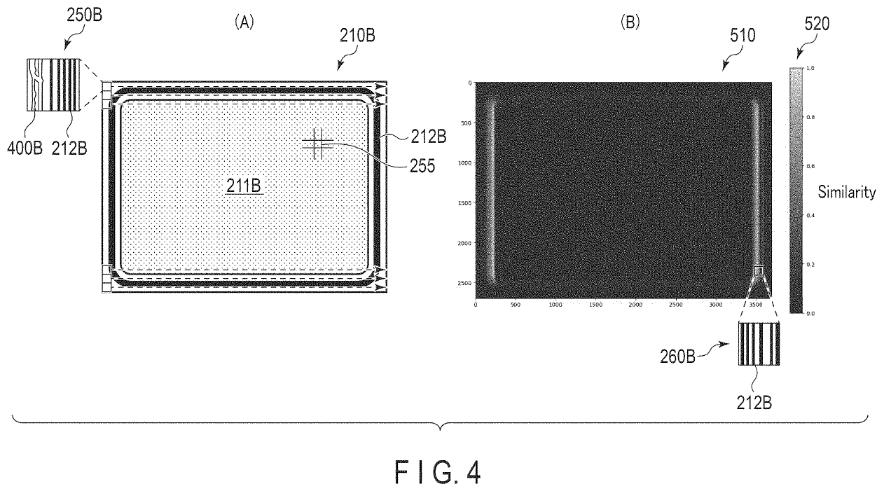

FIG. 4 is a diagram showing a first example of extracting the normal patch image 260 from the defect image 210 according to an embodiment. FIG. 4(A) shows a method of computing a similarity S between a partial image 255 of a defect image 210B and a defect patch image 250B. FIG. 4(B) shows a method of extracting a normal patch image 260B based on a similarity image 510 and a similarity scale 520. The similarity S is an example of the degree M of importance.

As shown in FIG. 4(A), the defect image 210B, like the defect image 210A, has a silicon substrate 211B and a circuit pattern 212B. One of the multiple partial images 255 of the defect image 210B corresponds to the defect patch image 250B. The defect patch image 250B includes a part of the circuit pattern 212B and a defect 400B.

The second extraction unit 12B moves the defect patch image 250B along the horizontal axis direction and the vertical axis direction of the defect image 210B. For example, the second extraction unit 12B moves the defect patch image 250B along the horizontal axis direction from the left end of the defect image 210B to the right end of the defect image 210B. The second extraction unit 12B repeats the aforementioned processing at each position in the vertical axis direction of the defect image 210B. In this manner, the second extraction unit 12B moves the defect patch image 250B over the entire defect image 210B. The second extraction unit 12B may move the defect patch image 250B pixel by pixel.

Next, the second extraction unit 12B computes a similarity S between the defect patch image 250B at each position after the movement and the partial image 255 of the defect image 210B at said position. At this time, the defect patch image 250B and the partial image 255 of the defect image 210B has the same resolution (number of pixels). The similarity between the two images is computed by a known method. The second extraction unit 12B outputs the similarity image 510 and the similarity scale 520 as a result of the computation of the similarity S.

As shown in FIG. 4(B), the similarity image 510 is an image showing a distribution of the similarity S between the defect patch image 250B and each of the partial images 255 of the defect image 210B. The numerical values attached to the horizontal axis and the vertical axis of the similarity image 510 indicate “the number of pixels”. The similarity scale 520 is a scale that associates the gradations of color of the similarity image 510 with the numerical values of the similarity S. The similarity S takes any value from a maximum value of “1.0” to a minimum value of “0.0”.

In the similarity image 510, an image region having a higher similarity S is shown in a brighter white color. As shown in the similarity image 510, the similarity S is relatively high at the left end and the right end (i.e., the portion where the circuit pattern 212B is positioned) of the semiconductor device. The second extraction unit 12B prioritizes the image region having a higher similarity S when cutting out the normal patch image 260B. At this time, the second extraction unit 12B cuts out the normal patch image 260B from an image region (i.e., the normal region NR) in the defect image 210B that does not include a defect.

The normal patch image 260B is an image that includes a part of the circuit pattern 212B. The resolution of the normal patch image 260B and the resolution of the defect patch image 250B are the same. In particular, the circuit pattern 212B of the normal patch image 260B is similar to the circuit pattern 212B of the defect patch image 250B. In other words, the normal patch image 260B is an image similar to the background of the defect patch image 250B.

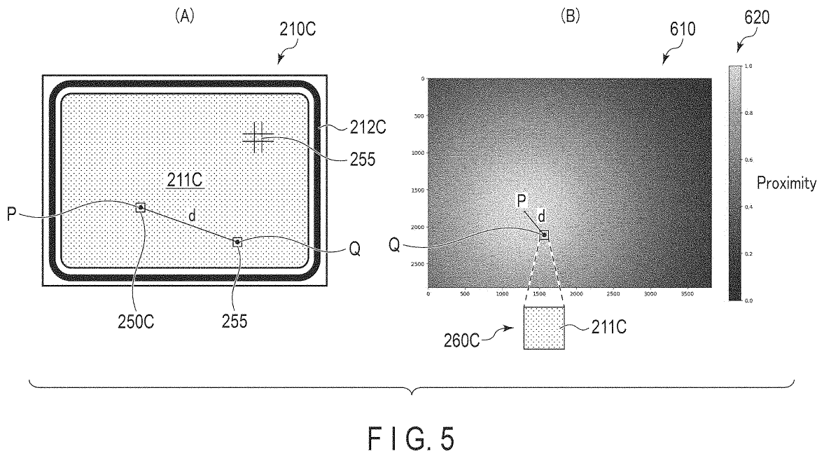

FIG. 5 is a diagram showing a second example of extracting the normal patch image 260 from the defect image 210 according to an embodiment. FIG. 5(A) shows a method of computing a distance d between a partial image 255 of a defect image 210C and a defect patch image 250C. FIG. 5(B) shows a method of extracting a normal patch image 260C based on a proximity image 610 and a proximity scale 620.

As shown in FIG. 5(A), the defect image 210C, like the defect image 210A, has a silicon substrate 211C and a circuit pattern 212C. By using the result of the estimation of a position P of a defect in the defect image 210C, the first extraction unit 12A cuts out a partial image region focusing on the position P of a defect as the defect patch image 250C (refer to step S3A). For example, the defect patch image 250C is cut out from a part of an image region of the silicon substrate 211C. The position P of a defect corresponds to one pixel.

The second extraction unit 12B specifies an image region in the defect image 210C that excludes the position P of a defect as a normal region NR (refer to step S4A). The second extraction unit 12B cuts out the partial image 255 focusing on any position Q in the normal region NR. For example, the partial image 255 is cut out from a part of an image region of the silicon substrate 211C. The position Q corresponds to one pixel.

The second extraction unit 12B computes a distance d between the position P of a defect in the defect patch image 250C and the position Q of the partial image 255. The distance d corresponds to an inter-pixel distance between the position P of a defect and the position Q. The inter-pixel distance is computed by a known method. The second extraction unit 12B outputs the proximity image 610 and the proximity scale 620 based on the computed distance d.

As shown in FIG. 5(B), the proximity image 610 is an image showing how short the distance d between the defect patch image 250C and the partial image 255 is (i.e., a proximity C). The shorter the distance d, the larger the proximity C; thus, the reciprocal of the distance d corresponds to the proximity C. The numerical values attached to the horizontal axis and the vertical axis of the proximity image 610 indicate “the number of pixels”. The proximity scale 620 is a scale that associates the gradations of color of the proximity image 610 with the numerical values of the proximity C. The proximity C takes any value from a maximum value of “1.0” to a minimum value of “0.0”. The proximity C is an example of the degree M of importance.

In the proximity image 610, an image region having a higher proximity C is shown in a brighter white color. As shown in the proximity image 610, the proximity C is higher in an image region closer to the position P of a defect in the semiconductor device. The second extraction unit 12B prioritizes the image region having a higher proximity C when cutting out the normal patch image 260C. At this time, the second extraction unit 12B cuts out the normal patch image 260C from an image region (i.e., the normal region NR) in the defect image 210C that does not include a defect.

The normal patch image 260C is an image that includes a part of the silicon substrate 211C. The resolution of the normal patch image 260C is the same as the resolution of the defect patch image 250C. In particular, the outer appearance of the silicon substrate 211C in the normal patch image 260C is similar to the outer appearance of the silicon substrate 211C in the defect patch image 250C. In other words, the normal patch image 260C is an image similar to the background of the defect patch image 250C.

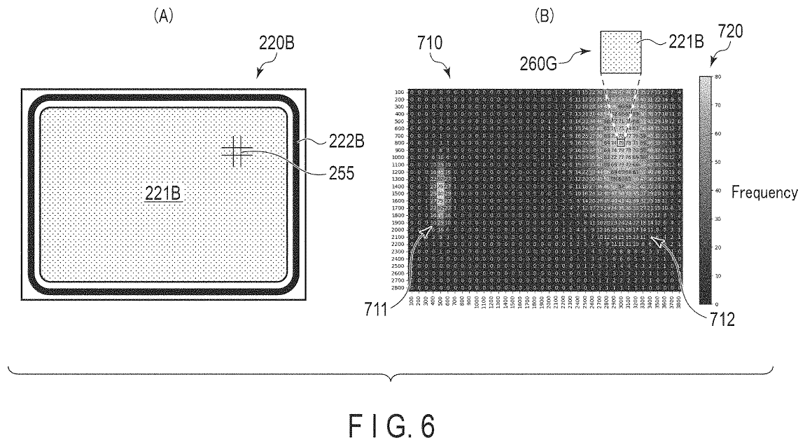

FIG. 6 is a diagram showing a first example of extracting the normal patch image 260 from the normal image 220 according to an embodiment. FIG. 6(A) shows a method of computing a frequency F of an occurrence of a defect in the partial image 255 of the normal image 220B. FIG. 6(B) shows a method of extracting a normal patch image 260G based on a frequency image 710 and a frequency scale 720. The frequency F of occurrence is an example of the degree M of importance.

As shown in FIG. 6(A), the normal image 220B, like the normal image 220A, has a silicon substrate 221B and a circuit pattern 222B. The second extraction unit 12B obtains multiple partial images 255 by dividing the normal image 220B in a grid manner. The second extraction unit 12B computes the frequency F of the occurrence (i.e., the number of occurrences) of a defect for each of the partial images 255.

As described above, the first extraction unit 12A extracts a partial image of the defect image 210 that includes a defect as the defect patch image 250 (refer to step S3A). At this time, the first extraction unit 12A may record the frequency F of the occurrence of a defect in a memory (not shown) for each partial image of the defect image 210. The first extraction unit 12A repeats the aforementioned processing for each of the partial images of the defect images 210. Thus, cumulative frequencies F of the occurrence of a defect are recorded in the memory for each of the partial images of the defect image 210.

The second extraction unit 12B computes the frequency F of the occurrence of a defect for each of the partial images 255 of the normal image 220B by referring to the aforementioned memory. The second extraction unit 12B outputs the frequency image 710 and the frequency scale 720 based on the computed frequency F of the occurrence of a defect.

As shown in FIG. 6(B), the frequency image 710 is an image showing a distribution of the frequency F of the occurrence of a defect for each of the partial images 255 of the normal image 220B. The numerical values attached to the horizontal axis and the vertical axis of the frequency image 710 indicate “the number of pixels”. The frequency image 710 is divided into multiple partial images each consisting of 100 pixels×100 pixels. The frequency scale 720 is a scale that associates the gradations of color of the frequency image 710 with the numerical values of the frequency F of the occurrence of a defect. The frequency F of occurrence takes any value from a maximum value of “80” to a minimum value of “0”.

In the frequency image 710, a partial image having a higher frequency F of occurrence is shown in a brighter white color. In particular, numerical values “0 to 80” indicating the frequency F of occurrence are attached to the respective partial images of the frequency image 710. On the left side of the frequency image 710, there is a small cluster 711 consisting of multiple partial images having a relatively high frequency F of occurrence. On the right side of the frequency image 710, there is a large cluster 712 consisting of multiple partial images having a relatively high frequency F of occurrence.

The second extraction unit 12B prioritizes the partial image having a higher frequency F of occurrence when cutting it out as the normal patch image 260G. For example, the second extraction unit 12B specifies a partial image with the highest frequency of occurrence “79” in the cluster 712. The second extraction unit 12B specifies, in the normal image 220B, the partial image 255 corresponding to the position of the specified partial image. The second extraction unit 12B cuts out the specified partial image 255 as the normal patch image 260G.

The normal patch image 260G is an image that includes a part of the silicon substrate 221B. The resolution of the normal patch image 260G is the same as the resolution of the partial image 255 of the normal image 220B. In particular, it is expected that the outer appearance of the silicon substrate 221B in the normal patch image 260G is similar to the outer appearance of the silicon substrate in the defect patch image 250. In other words, the normal patch image 260G is an image expected to be similar to the background of the defect patch image 250.

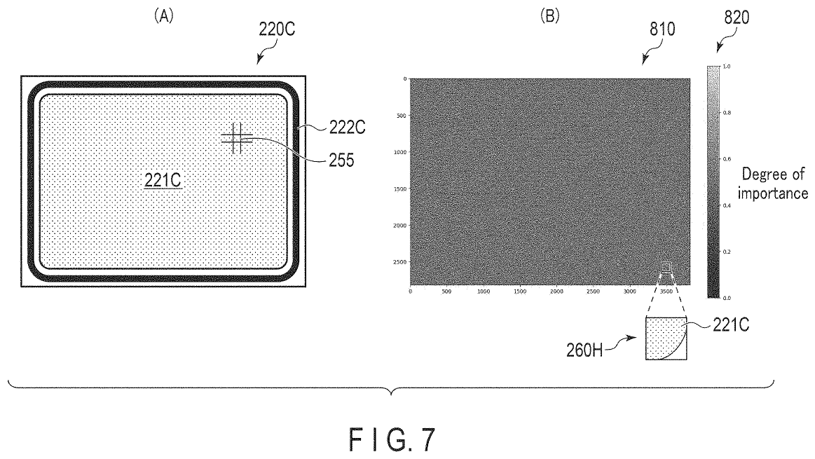

FIG. 7 is a diagram showing a second example of extracting the normal patch image 260 from the normal image 220 according to an embodiment. FIG. 7(A) shows a method of computing a degree M of importance for each of the partial images 255 in the normal image 220C. FIG. 7(B) shows a method of extracting a normal patch image 260H based on a degree-of-importance image 810 and a degree-of-importance scale 820.

As shown in FIG. 7(A), the normal image 220C, like the normal image 220A, has a silicon substrate 221C and a circuit pattern 222C. The second extraction unit 12B sets the same degree M of importance over the entire normal image 220C. The second extraction unit 12B outputs the degree-of-importance image 810 and the degree-of-importance scale 820 based on the set degree M of importance.

As shown in FIG. 7(B), the degree-of-importance image 810 is an image showing a distribution of the degree M of importance for each of the partial images 255 of the normal image 220C. The numerical values attached to the horizontal axis and the vertical axis of the degree-of-importance image 810 indicate “the number of pixels”. The degree-of-importance scale 820 is a scale that associates the gradations of color of the degree-of-importance image 810 with the numerical values of the degree M of importance. The degree M of importance takes any value from a maximum value of “1.0” to a minimum value of “0.0”.

In the degree-of-importance image 810, a partial image having a higher degree M of importance is shown in a brighter white color. In particular, the same degree of importance “0.5” is attached to the respective partial images of the degree-of-importance image 810.

The second extraction unit 12B prioritizes the partial image having a higher degree M of importance when cutting it out as the normal patch image 260H. As described above, the same degree M of importance is uniformly distributed over the entire degree-of-importance image 810. Thus, the second extraction unit 12B randomly extracts the normal patch image 260H from any position in the degree-of-importance image 810. For example, the second extraction unit 12B specifies, in the normal image 220C, the partial image 255 corresponding to the position of the partial image on the lower right of the degree-of-importance image 810. The second extraction unit 12B cuts out the specified partial image 255 as the normal patch image 260H.

The normal patch image 260H is an image that includes a part of the silicon substrate 221C. The resolution of the normal patch image 260H is the same as the resolution of the partial image 255 of the normal image 220C. In particular, it is expected that the outer appearance of the silicon substrate 221C in the normal patch image 260H is similar to the outer appearance of the silicon substrate in the defect patch image 250. In other words, the normal patch image 260H is an image expected to be similar to the background of the defect patch image 250.

The second extraction unit 12B may randomly extract the normal patch image 260 from the defect image 210 using a similar method to the above. In particular, the second extraction unit 12B may randomly extract the normal patch image 260 from the normal region NR of the defect image 210.

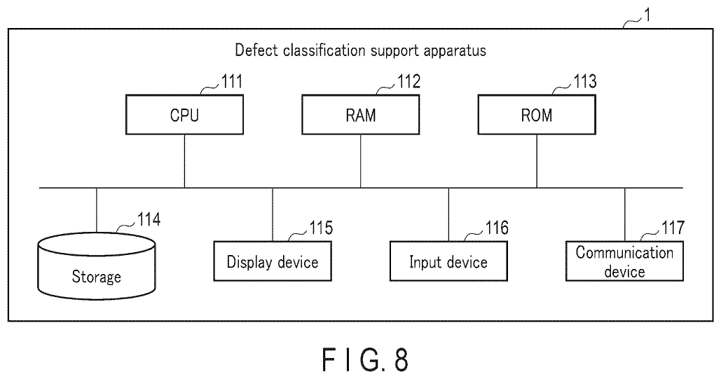

FIG. 8 is a block diagram showing an example of a hardware configuration of the defect classification support apparatus 1 according to an embodiment. The defect classification support apparatus 1 includes a CPU 111, a RAM 112, a ROM 113, a storage 114, a display device 115, an input device 116, and a communication device 117 as its components. These components are communicably connected to one another via a bus (BUS). The defect classification support apparatus 1 may include at least one or more of the components.

The CPU 111 is a processor that executes various kinds of processing according to a program(s). The CPU 111 uses a predetermined area of the RAM 112 as a work area. The CPU 111 realizes each unit (the acquisition unit 11, the first extraction unit 12A, the second extraction unit 12B, and the computation unit 13) of the defect classification support apparatus 1 by reading and executing each program stored in the ROM 113 or the storage 114. The CPU 111 is an example of a processor.

The RAM 112 is a memory for storing various types of data so as to permit rewriting. For example, the RAM 112 is a synchronous dynamic random access memory (SDRAM). The RAM 112 is an example of a storage.

The ROM 113 is a memory for storing various types of data so as not to permit rewriting. The ROM 113 is an example of a storage.

The storage 114 is various kinds of storage media. Alternatively, the storage 114 may be a drive unit that writes or reads various types of data to and from a storage medium. The storage 114 writes or reads various types of data to and from a storage medium under the control of the CPU 111. The storage 114 is an example of a storage unit.

The display device 115 is a device for displaying various types of data. For example, the display device 115 is a liquid crystal display (LCD). The display device 115 displays various types of data based on a display signal from the CPU 111. The display device 115 is an example of a display unit.

The input device 116 is a device for inputting various types of data to the defect classification support apparatus 1. For example, the input device 116 is a mouse or a keyboard. The input device 116 receives information input by a user as an instruction signal, and transfers the instruction signal to the CPU 111. The input device 116 is an example of an input unit.

The communication device 117 communicates with external devices via a network under the control of the CPU 111. The communication device 117 is an example of a communication unit.

The various kinds of processing performed by the defect classification support apparatus 1 may be performed by a general-purpose computer (e.g., a personal computer, a microcomputer, a computing device). For example, a general-purpose computer stores the programs corresponding to the various kinds of processing in a storage medium, and reads the programs from the storage medium to execute them. Alternatively, a general-purpose computer reads and executes a program(s) from an external storage medium connected thereto by a network (e.g., a LAN, the Internet). Thus, a general-purpose computer can perform processing similar to the processing performed by the defect classification support apparatus 1.

The storage medium may be a magnetic disk (e.g., a flexible disk, a hard disk), an optical disk (e.g., CD-ROM, CD-R, CD-RW, DVD-ROM, DVD+R, DVD+RW, Blu-ray (registered trademark) disk), a semiconductor memory, or a storage medium similar to them. The storage medium may download and store a program from a network. Needless to say, multiple programs may be respectively stored in multiple storage media.

Instead of a single computer, an actor such as a system composed of multiple computers, an operating system (OS), database management software, or middleware (MW) may perform processing similar to the processing performed by the defect classification support apparatus 1.

According to the embodiment described above, the defect classification support apparatus 1 acquires the defect image 210 of an outer appearance of a target object having a defect D by implementing the acquisition unit 11. With the first extraction unit 12A, the defect classification support apparatus 1 extracts the defect patch image 250 (a partial image) having the defect D from the defect image 210. With the second extraction unit 12B, the defect classification support apparatus 1 extracts the partial normal patch image 260 (a partial image) free of the defect D from the defect image 210. With the computation unit 13, the defect classification support apparatus 1 computes a feature amount (the defect feature amount 300) of the defect D based on the defect patch image 250 and the normal patch image 260.

That is, the defect classification support apparatus 1 does not use “a design image” or “a pseudo-normal patch image” as in the conventional method. Instead, the defect classification support apparatus 1 uses the defect patch image 250 and the normal patch image 260 extracted from the defect image 210; thus, the defect classification support apparatus 1 can highly accurately compute the feature amount of the defect D in the defect patch image 250.

Furthermore, the defect classification support apparatus 1 extracts a partial image 255 having a higher similarity S as the normal patch image 260, the similarity S being a similarity between the defect patch image 250 and each of the partial images 255 of the defect image 210. In general, the CIDFD method uses a normal patch image 260 more similar to the background (a normal feature) of the defect patch image 250, thereby being able to more effectively suppress the feature amount (a normal feature amount) of the background. Therefore, the defect classification support apparatus 1 can highly accurately compute the feature amount of the defect D in the defect patch image 250.

Furthermore, the defect classification support apparatus 1 extracts a partial image 255 having a shorter distance d as the normal patch image 260, the distance d being a distance between the defect patch image 250 and each of the partial images 255 of the defect image 210. In general, the normal patch image 260 at a position closer to the position of the defect patch image 250 is more similar to the defect patch image 250. That is, since the defect classification support apparatus 1 uses a normal patch image 260 more similar to the defect patch image 250, it can highly accurately compute the feature amount of the defect D in the defect patch image 250.

Furthermore, the defect classification support apparatus 1 extracts a predetermined number of normal patch images 260 from the defect image 210 and the normal image 220 according to the number of defect patch images 250. For example, the defect classification support apparatus 1 limits the number of normal patch images 260 according to the number of defect patch images 250. In general, if there are a relatively large number of normal patch images 260 as compared to the number of defect patch images 250, the CIDFD method cannot compute the feature amount of the defect D in the defect patch image 250 with high accuracy. Therefore, the defect classification support apparatus 1 can highly accurately compute the feature amount of the defect D in the defect patch image 250 by adjusting the number of normal patch images 260.

Furthermore, the defect classification support apparatus 1 randomly extracts the normal patch image 260 from the defect image 210 and the normal image 220. Thus, the defect classification support apparatus 1 can highly accurately compute the feature amount of the defect D in the defect patch image 250 based on the defect patch image 250 and the normal patch image 260.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A defect classification support apparatus comprising a processor configured to:
acquire a defect image of an outer appearance of a target object having a defect;
extract a defect patch image from the defect image, the defect patch image being a partial image that includes the defect;
extract a normal patch image from the defect image, the normal patch image being a partial image free of the defect; and
compute a feature amount of the defect based on the defect patch image and the normal patch image.

2. The defect classification support apparatus according to claim 1, wherein the processor extracts, among partial images of the defect image, a partial image having a higher similarity to the defect patch image as the normal patch image.

3. The defect classification support apparatus according to claim 1, wherein the processor extracts, among partial images of the defect image, a partial image having a shorter distance to the defect patch image as the normal patch image.

4. The defect classification support apparatus according to claim 1, wherein the processor extracts a predetermined number of the normal patch images from the defect image according to a number of the defect patch images.

5. The defect classification support apparatus according to claim 1, wherein the processor randomly extracts the normal patch image from the defect image.

6. The defect classification support apparatus according to claim 1, wherein the processor
further acquires a normal image of an outer appearance of another target object free of the defect, further extracts another normal patch image free of the defect from the normal image, the another normal patch image being a partial image, and
computes the feature amount of the defect based further on the another normal patch image.

7. The defect classification support apparatus according to claim 6, wherein the processor extracts, among partial images of the normal image, a partial image having a higher frequency of occurrence of the defect as the another normal patch image.

8. The defect classification support apparatus according to claim 6, wherein the processor extracts a predetermined number of the normal patch images and a predetermined number of the another normal patch images from the defect image and the normal image according to a number of the defect patch images.

9. The defect classification support apparatus according to claim 6, wherein the processor randomly extracts the another normal patch image from the normal image.

10. A defect classification support method comprising:
acquiring a defect image of an outer appearance of a target object having a defect;
extracting a defect patch image from the defect image, the defect patch image being a partial image that includes the defect;
extracting a normal patch image from the defect image, the normal patch image being a partial image free of the defect; and
computing a feature amount of the defect based on the defect patch image and the normal patch image.

11. A non-transitory computer readable medium including computer executable instructions, wherein the instructions, when executed by a processor, cause the processor to perform a method comprising:
acquiring a defect image of an outer appearance of a target object having a defect;
extracting a defect patch image from the defect image, the defect patch image being a partial image that includes the defect;
extracting a normal patch image from the defect image, the normal patch image being a partial image free of the defect; and
computing a feature amount of the defect based on the defect patch image and the normal patch image.
